(19) United States
(12) Patent Application Publication
(10) Pub. No.: US 2003/0182277 A1
(43) Pub. Date: Sep. 25, 2003

(54) Information search method and apparatus

(76) Inventor: Yasushi Kurakake, Yokohama-shi (JP)

Correspondence Address: HARNESS, DICKEY & PIERCE, P.L.C., P.O. BOX 828, BLOOMFIELD HILLS, MI, 48303, US

(21) Appl. No.: 10/386,864

(22) Filed: Mar. 12, 2003

(30) Foreign Application Priority Data
Mar. 19, 2002 (JP) 2002-076673

(51) Int. Cl. G06F 7/00

(52) U.S. Cl. 707/3

(57) ABSTRACT

Terminal devices of a plurality of users and a server apparatus are connected via a communication network. First search step performed by the server apparatus searches a database, on the basis of information about a particular user, for one or more other users. For example, the first search step specifies at least one artist (e.g., favorite artist) or work from the database, and then searches the database for one or more other users using the specified artist or work as an augment. Second search searches the database for one or more artists (e.g., favorite artist) or works, using, as augments, the one or more other users searched out from the database. Then, the thus searched-out favorite artists or works of the other users are presented to the particular user.

### BACKGROUND OF THE INVENTION

The present invention relates to information search methods and apparatus for, in response to a request from a user having accessed via a communication network, searching for information about user-desired content, such as a music piece or visual image, and then presenting searched-out information to the user. More particularly, the present invention relates to an improved or novel information search method and apparatus which, in response to a request from a user having accessed via a communication network, can locate information about user-desired content that suits a peculiar taste of the requesting user and is considerably unexpected (beyond prior expectation of the user) and interesting to the user and then visually present the located or searched-out information to the user.

Today, with development of communication networks, such as the Internet, and thanks to various information distribution services provided by server apparatus via such communication networks, everybody can search for various desired information and read, purchase, rent and utilize various desired content (e.g., music piece, sound, visual image/video or software program) anywhere and at any time. For example, any interested user can enjoy a desired music piece on a terminal device, such as a personal computer or PDA (Personal Data (Digital) Assistant), by accessing, via a communication network like the Internet, an information search server apparatus (e.g., WWW (World-Wide Web) server apparatus) that provides a desired music piece distribution service and selectively obtaining a desired music piece from among a multiplicity of music pieces stored in the server apparatus. Generally, to select a desired music piece to be provided, the user directly selects the desired music piece on the basis of the title, genre, artist's name and/or the like of the music piece. In this manner, visual presentation, selection and supply of content are executed between the terminal device and the server apparatus connected with each other via the communication network. It is conventionally known that given content having been newly added to the music piece distribution service of a server apparatus and/or other suitable content is set or registered in advance, as “recommendable content” (e.g., “recommendable new tune for the month”), in an information provider (e.g., content provider or administrator of the music piece distribution service) and that the thus-registered recommendable content is presented to interested users so that time and labor etc. required for the users to select desired content may be reduced significantly.

However, because conventional lists of content (or lists of works), such as “lists of recommendable content”, presented from server apparatus to interested users are merely fixed lists that are set or registered in advance by information providers, they necessarily fail to reflect tastes and tendencies of individual users in a constantly updated manner. It is also difficult and laborious for the information providers to previously set or register lists of content (lists of works) reflecting tastes and tendencies of individual users. Thus, the conventional lists of content (or lists of works), such as “recommendation lists”, tend to be stereotyped to every user, lacking interest and unexpectedness, and users have to locate their desired content with their extra labor. But, to date, it has been very troublesome and time-consuming for users to locate, by themselves, desired content, suiting their tastes and having interest and unexpectedness, from among an enormous number of items of content stored in the server apparatus.

### SUMMARY OF THE INVENTION

In view of the foregoing, it is an object of the present invention to provide a novel and useful information search method and apparatus which can be effectively applied to purchase, rent, utilization, etc. works (items of content) in various fields such as karaoke, video, novel and comic. For example, the present invention seeks to provide an information search method and apparatus which can present, to any requesting user, information about content that is considerably unexpected and interesting to the user, by specifying a different recommendable artist to each user using a statistical scheme.

In order to accomplish the above-mentioned object, the present invention provides an information search method for use in a system including a database storing pieces of information about a plurality of users and artists and/or works registered in association with the plurality of users, which comprises: a first search step of, on the basis of information about a particular user, searching the database for one or more other users; a second search step of searching the database for one or more artists or works, using, as augments, the one or more other users searched out from the database by the first search step; and a step of presenting, to the particular user, search results based on the one or more artists or works searched out from the database by the second search step.

As an example, the first search step may include a step of specifying at least one artist or work in relation to the particular user, and a step of searching the database for the one or more other users using the specified at least one artist or work as an augment. The step of presenting may include a step of extracting, in accordance with a predetermined extraction criterion, at least one recommendable artist or recommendable work from among the one or more artists or works searched out from the database as noted above, and the step of presenting presents the extracted recommendable artist or recommendable work to the particular user. Further, the predetermined extraction criterion may be based on a predetermined statistical algorithm. Furthermore, the predetermined statistical algorithm is designed to select, as the at least one recommendable artist or recommendable work, an artist or work having been designated most frequently by the one or more other users.

Namely, the present invention is constructed to search for (i.e., find or locate) artists or works that are registered in the database in relation to other users who appear to have some close connections or similarities in hobby and taste to the particular user, and then it presents the search results to the particular user. This way, the present invention can locate and present, to any requesting user, search results that suit a peculiar taste of the user and are considerably unexpected (beyond prior expectation of the user) and interesting to the user. For example, the present invention presents most-frequently-designated (selected) artists on the basis of accumulated statistical data; by so doing, the present invention can present, to each requesting user, search results that suit a peculiar taste of the user and are considerably unexpected and interesting to the user. Namely, once a specific artist is selected or designated by a particular user, the present invention locates and specifies other users who have also designated the same specific artist as the particular user. Because the other users have previously designated other artists than the specific artist in most cases, the present invention obtains the names of such other artists and determines, as the most-frequently-designated artist, an artist having been designated by the greatest number of the users so as to present the most-frequently-designated artist to the requesting user. Because the most-frequently-designated artist, determined statistically from among the artists having been designated by the other users, is presented to the requesting user, the present invention can effectively present, to each requesting user, search results that suit a peculiar taste of the user and are considerably unexpected (beyond prior expectation of the requesting user) and interesting to the user.

The present invention may be constructed and implemented not only as the method invention as discussed above but also as an apparatus invention. Also, the present invention may be arranged and implemented as a software program for execution by a processor such as a computer or DSP, as well as a storage medium storing such a program. Further, the processor used in the present invention may comprise a dedicated processor with dedicated logic built in hardware, not to mention a computer or other general-purpose type processor capable of running a desired software program.

While the embodiments to be described herein represent the preferred form of the present invention, it is to be understood that various modifications will occur to those skilled in the art without departing from the spirit of the invention. The scope of the present invention is therefore to be determined solely by the appended claims.

### BRIEF DESCRIPTION OF THE DRAWINGS

For better understanding of the object and other features of the present invention, its preferred embodiments will be described hereinbelow in greater detail with reference to the accompanying drawings, in which:

FIG. 1 is a block diagram showing a general setup of an embodiment of an information delivery system employing an information search apparatus of the present invention;

FIG. 2 is a hardware block diagram showing an exemplary overall hardware setup of any one of user terminal devices and search server apparatus;

FIG. 3 is a flow chart explanatory of various operations executed by the user terminal device and search server apparatus in the information delivery system; and

FIG. 4 is a flow chart showing an example of a recommendation search process carried out by the search server apparatus in the information delivery system of FIG. 1.

### DETAILED DESCRIPTION OF THE EMBODIMENTS

FIG. 1 is a block diagram of an embodiment of an information delivery system employing an information search apparatus of the present invention. The information delivery system of FIG. 1 includes user terminal devices A, such as personal computer terminals and portable (e.g., cellular) phones, at least one information search server apparatus B, and a communication network X connecting the user terminal devices A and search server apparatus B. As will be later described in detail, the devices and apparatus (i.e., user terminal devices A and search server apparatus B), constituting the information delivery system of FIG. 1, each comprise an independent computer including a CPU, ROM, RAM, communication facilities, etc; each of these devices and apparatus can transmit or receive various information or content either via the communication network X, such as the Internet or dedicated line, or via wireless communication.

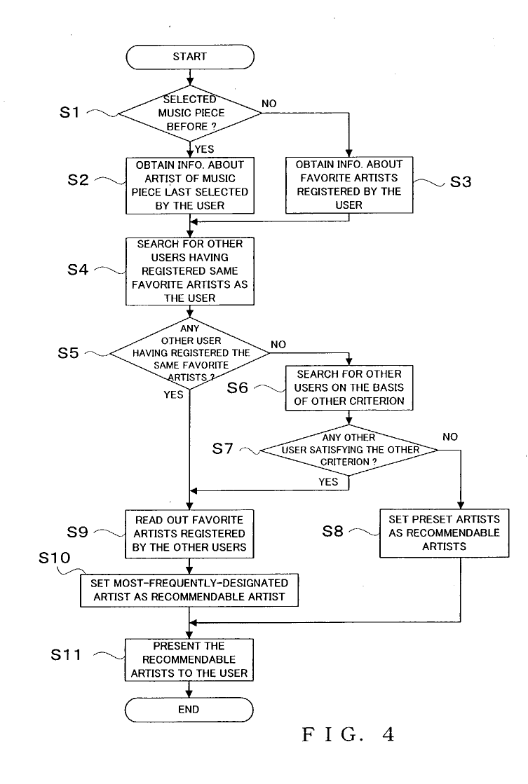

In the information delivery system of FIG. 1, the user of each of the user terminal devices A can use a predetermined software program, such as a well-known network browser, to select, from among a plurality of sites (i.e., sites presenting various information, data, etc. in predetermined display styles) stored in the search server apparatus B, a particular site (hereinafter referred to as an “information delivering site”) that provides a user-desired information delivery service. The information search server apparatus B, storing the selected information delivering site, searches through a database (DB), containing various pieces of information, in accordance with a previously-installed predetermined search engine (e.g., a software program of a “recommendable search process” to be later described in relation to FIG. 4), and the information search server apparatus B supplies thus-obtained (searched-out or located) content or the like to the user terminal device A. Namely, the information delivery system of FIG. 1 is a network system that permits various operations as noted above using an existing communication network X.

Of course, the information delivery system of FIG. 1 may include other hardware than the above mentioned, but it will be described as using minimum necessary resources for purposes of clarity.

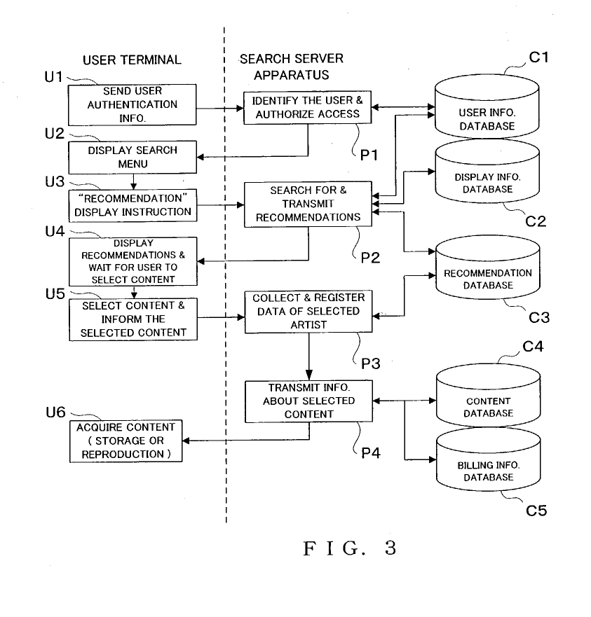

Each of the user terminal devices A, constituting the information delivery system of FIG. 1, can access any one of a plurality of sites stored in the information search server apparatus B, in accordance with an access request (e.g., designation of a URL (Uniform Resource Locator)) made by the user. For example, each of the sites stored in the search server apparatus B on the communication network X is managed as HTML files that are display information forming a basis of a plurality of Web pages described in HTML (Hyper Text Markup Language), and each of the HTML files has added thereto a URL indicative of an address on the communication network X. For example, each of the URLs is an Internet address to be used to designate an HTML file stored in the particular search server apparatus B, and it comprises information indicative of a predetermined character string. Each of the user terminal devices A or clients can read out a desired HTML file from the search server apparatus B by designating the URL of the desired HTML, and display the site on the basis of the read-out HTML file. Technique for displaying the site based on the HTML file is well-known, and thus description of such a technique is omitted here. Upon accessing a desired information delivering site from among the multiplicity of sites, the user terminal device A can receive content transmitted by the search server apparatus B storing the accessed information delivering site and then store and reproduce the received content. Details of such operations will be given later with primary reference to FIG. 3.

The search server apparatus B, constituting the information delivery system of FIG. 1 along with the aforementioned user terminal devices A, is a server computer which has a multiplicity of HTML files, items of content and various other information, etc., to be used for display of desired sites in the user terminal devices A, prestored in the database (DB), and which, in response to a request from any one of the user terminal devices A connected thereto via the communication network X, reads out desired information from the database and transmits the read-out information to the user terminal device A. Namely, the search server apparatus B provides an information delivery service. For example, the search server apparatus B performs: a process for, in response to an access request from any one of the user terminal devices A to a desired information delivering site, transmitting an HTML file, related to the requested information delivering site, to the user terminal device A; a process for, in response to a content request from any one of the user terminal devices A, transmitting the requested content to the user terminal device A; a process for, in response to a recommendation request from any one of the user terminal devices A, transmitting a most-frequently-designated (most popular) artist, located from the database (DB) by a predetermined search engine, to the user terminal device A as a “recommendation”; and various other processes.

Needless to say, various databases and search engines may be constructed as hardware independent of the search server apparatus B.

Portable (e.g., cellular) phones, PDA, etc., used as the user terminal devices A, are small-size portable terminal devices capable of wireless communication, each of which has, in addition to its primary communication function, a display function for displaying a site and a content reproduction function for reproducing content. Namely, similarly to personal computers and the like, each of the portable terminal devices includes a display device capable of displaying a user-desired information delivering site, various circuits and systems for receiving content from the search server apparatus B and storing and reproducing the received content. However, in order to connect such a portable terminal device and the search server apparatus B for bidirectional communication therebetween, a relay server (not shown) must intervene. Namely, the portable terminal device can access the search server apparatus B by the relay server relaying signal communication (transmission/reception) between the portable terminal device and the search server apparatus B.

Note that the user terminal devices A are not limited to personal computer terminal devices, portable terminal devices (i.e., PDAs and portable phones), etc. and may be any type of equipment as long as they can acquire a desired HTML file, content, etc. from the search server apparatus B and process the acquired desired HTML file, content, etc. Specifically, the user terminal devices A may be fixed phones, game devices, set-top boxes, electronic musical instruments, etc. Further, in the embodiment of FIG. 1, a plurality of the search server apparatus B as well as a plurality of the user terminal devices A may be connected to the communication network X. Whereas the embodiment of FIG. 1 has been described as displaying a site on the basis of an HTML file, it may of course be constructed to display a site on the basis of another similar file (e.g., file using a page description language or the like).

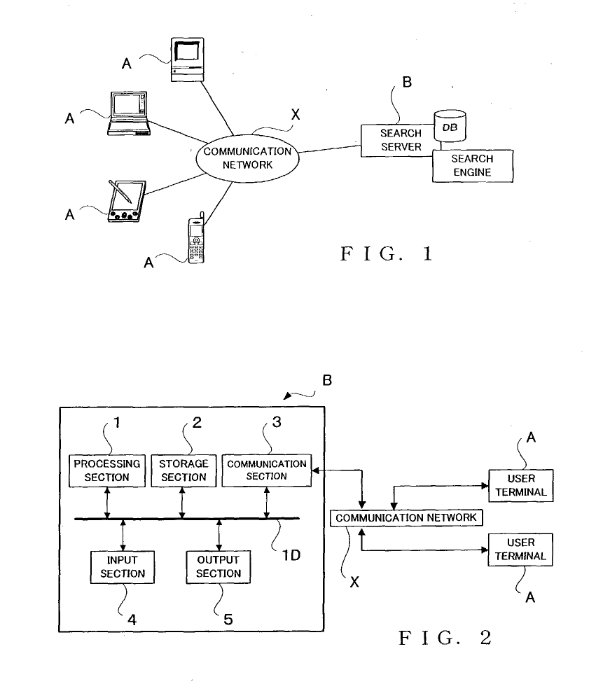

Now, a description will be given about an exemplary hardware setup of any one of the user terminal devices A and search server apparatus B constituting the information delivery system, with reference to FIG. 2. FIG. 2 is a hardware block diagram showing an exemplary overall hardware setup of a representative one of the user terminal devices A and search server apparatus B. Note that because all of the user terminal devices A and search server apparatus B can be described as using a similar hardware setup, FIG. 2 representatively shows the overall hardware setup of only one of the search server apparatus B.

The search server apparatus B shown in FIG. 2 is constructed to perform various processes under control of a processing section 1 that comprises a microprocessor unit (CPU), a read-only memory (ROM) and a random access memory (RAM). The CPU controls all operations of the search server apparatus B. The ROM stores therein various control programs, such as search engines, to be executed by the CPU. The RAM is used as a working memory for temporarily storing various data generated as the CPU executes a program, a memory for storing a currently-executed program and data related thereto, etc. Predetermined address regions are assigned to respective predetermined functions and used as registers, tables, memories and the like. The processing section 1 provides an information delivery service to any of the user terminal devices A by executing a predetermined program. Storage section 2, communication section 3, input section 4 and output section 5 are connected via a data and address bus 1D to the processing section 1.

The storage section 2 is an internal storage device, such as a ROM or RAM, or an external storage device, such as a hard disk, which has stored therein HTML files, content, various databases, icon information and various control programs, such as search engines, to be executed by the CPU. The storage section 2 stores various databases, among which are a user information database, display information database, recommendation-index information database, content database, billing information database, etc. The user information database is provided for storing various pieces of user information, such as user IDs, authentication information, names, dates of birth, sexes, names of favorite artists of users, music-piece-selection history information about the users, etc. The names of favorite artists to be stored in the user information database can be entered by a user at such a time when information about the user is to be registered for receiving the information delivery service or at any given time. Alternatively, the names of favorite arts of a user may be automatically identified and set statistically on the basis of a history record of content acquired by the user from the search server apparatus B; for example, top five artists, having been so far designated or selected frequently by the user, may be automatically specified and set as his or her favorite artists. The display information database is provided for storing display information to be visually displayed on an output section 5 as will be later described; for example, this display information database stores, as the display information, outlines, purchase prices and previews of various items of content, a list of content, etc.

Further, the recommendation-index information database is provided for storing index information to be used to search for particular recommendable artists; for example, IDs of recommendable artists, user characteristics (IDs, ages, sexes, etc. of users having so far selected the recommendable artists), IDs of other artists so far selected by the users having selected the recommendable artists, etc. are stored as the index information. In this recommendation-index information database, pieces of index information are accumulated after being classified according to the user characteristics and/or connections between particular artists and other artists at the time of acquisition of content (e.g., statistical information indicating that there is a tendency for artist A and artist B to be designated by a same user). Such index information accumulation may be executed by periodical batch processing or by real-time processing. The content database is provided for storing pieces of content information, such as content IDs and content (substance) data like music piece data and image data. The billing information database is provided for storing pieces of compensation settlement information corresponding to supply of content, such as content IDs, IDs of users having purchased the content and pieces of billing information.

The above-mentioned “artist” refers to an actual human player having performed a music piece in the case where the information delivery system is a music-piece delivery system that delivers content of a music piece and the like; however, the “artist” may be a composer, lyric writer, arranger, producer or the like of a music piece. Where the information delivery system is an image/video delivery system that delivers content of an image, video and the like, the “artist” may be a producer (director) of an image or video, actor or actress, playwright or the like.

In a case where a particular control program is not prestored in the ROM of the processing section 1, the particular control program may be prestored in the storage section 2, so that, by reading the control program from the storage section 2 into the RAM of the processing section 1, the CPU is allowed to operate in exactly the same way as in the case where the particular control program is stored in the ROM. This arrangement greatly facilitates version upgrade of the control program, addition of a new control program, etc. External storage device functioning as the storage section 2 may comprise any of various removable-type media other than a hard disk (HD), such as a floppy disk (FD), compact disk (CD-ROM or CD-RAM), magneto-optical disk (MO), digital versatile disk (DVD) and semiconductor memory.

Communication section 3 is an interface connected to the communication network X, such as a LAN, Internet or telephone line network, which, when connected via the communication network X to a predetermined user terminal device A, allows the user terminal device A to transmit an information request to the search server apparatus B and allows the search server apparatus B to transmit an HTML file, content etc. to the user terminal device A. For example, in the instant embodiment, the communication section 3 is used to transmit, to the user terminal device A, one or more HTML files relating to a desired information delivery site, content capable of being delivered from the desired information delivery site, etc.

Note that the communication section or interface 3 and communication network X may each be of a wireless type using, for example, a wireless LAN like IEEE802.11b, rather than being limited to a wired type using a general-purpose interface like RS-232C, USB (Universal Serial Bus) or IEEE1394. Alternatively, the communication section 3 and communication network X may be constructed to be capable of both wired communication and wireless communication.

The input section 4 in the illustrated example of FIG. 2 comprises a mouse and a keyboard, or switches connected to the body of the search server apparatus B. The input section 4 may comprise any component as long as the component can be used as an operator operable by the user. For example, the input section 4 may comprise a ten-button keypad for entering numerical value data and a keyboard for entering character data like data of a URL, or a mouse and panel switches. The output section 5 comprises, for example, a display unit including a liquid crystal display (LCD) panel, CRT (Cathode Ray Tube) and/or LEDs. The output section 5 displays one or more “recommendable artists” presented by the search server apparatus B, outline of received content, controlling state of the CPU 1, etc., not to mention a search menu to be used for searching information delivery sites and various items of content stored in the information delivery sites.

Note that in a case where the search server apparatus B is constructed to specialize in information delivery alone as an information delivery service server, the search server apparatus B need not necessarily be equipped with the above-mentioned input section 4 and output section 5.

Next, a description will be given about a series of operations, carried out respectively by the user terminal device A and search server apparatus B constituting the information delivery system of FIG. 1, from a start of access by the user to acquisition of content by the user, with reference to FIG. 3. FIG. 3 is a flow chart explanatory of the operations carried out respectively by the user terminal device A and search server apparatus B constituting the information delivery system. Although, in reality, the user terminal device A and search server apparatus B carry out the operations, from the start of access by the user to the acquisition of content by the user, independently of each other, the operations carried out by the user terminal device A and search server apparatus B will be explained along a substantially single series of processing flows, to facilitate understanding. Namely, since the user terminal device A having sent an access request and the search server apparatus B having received the access request carry out their respective operations in a parallel fashion while transmitting and receiving various predetermined information to and from the other party, the respective operations will be described along the information transmission/reception flows.

First, at step U1, the user terminal device A sends user authentication information to the search server apparatus B connected to the communication network X, in order to start access to the search server apparatus B that provides a desired information delivery service via the communication network X. Once the user authentication information has been received from the user terminal device A, the search server apparatus B identifies the user on the basis of the received user authentication information and returns an access authorization to the user terminal device A, at step P1. Namely, the user authentication information sent from the user terminal device A is a connection request requesting a start of access to the search server apparatus B, and the server apparatus B ascertains, on the basis of the user authentication information, whether or not the requesting user is an already-registered user duly qualified to receive the information delivery service from the server apparatus B. Specifically, the ascertainment of the user is effected by reference to the user information database Cl, and the search server apparatus B authorizes the requested access only when the user has been identified as an already-registered user duly qualified to receive the information delivery service from the server apparatus B.

Note that the user terminal device A normally effects the transmission of the user authentication information by first prompting the user to enter the user's name and password when the user has instructed access to the search server apparatus B providing the desired information delivery service. However, in a case where the user terminal device A is uniquely identifiable, e.g. where the user terminal device A is a telephone terminal device like a portable phone or other equipment fixedly assigned an IP address, the user authentication may be replaced with the identification of the user terminal device A; in such a case, explicit user authentication as noted above may be dispensed with.

At next step U2, the user terminal device A, having received an access authorization from the search server apparatus B in response to the user authentication information transmitted to the server device B, displays, on its output section 5 such as a visual display, a “search menu” (not shown) for searching for user-desired content from among a multiplicity of content stored in the search server apparatus B. The “search menu” includes an area where the user can directly enter various search conditions or criteria, such as the title, genre and artist's name of a music piece, to search for user-desired content, and it also includes a “recommendation” button. When the user has activated or operated the “recommendation” button without directly entering any search criterion, the user terminal device A transmits a “recommendation” display instruction to the search server apparatus B now being connected with the user terminal device A, at step U3. Upon receipt of the recommendation display instruction from the terminal device A, the search server apparatus B carries out a recommendation search process on the basis of the user information database C1, display information database C2 and recommendable artist database C3, and then the server apparatus B sends one or more “recommendable artists”, having been set on the basis of the results of the search, back to the user terminal device A, at step P2. Namely, although the search server apparatus B is constructed to be able to directly search for user-desired content in accordance with search criteria entered via the search menu, when the recommendation button has been operated, the search server apparatus B presents one or more “recommendable artists” to the user without conducting the direct content search based on search criteria. The presentation of the recommendable artists in the recommendation search process is not detailed here since it will be described in detail later.

Once the reply to the recommendation display instruction, i.e. the presentation of the recommendable artists, has been received from the search server apparatus B, the user terminal device A causes the output section 5 to display the received recommendable artists and waits for the user to select desired content, at step U4. Specifically, the names of the recommendable artists are displayed along with their works (i.e., content such as music pieces, visual images, videos, poems and/or novels) performed or created by the individual artists. Then, the user selects a desired one of the works displayed on the output section 5. In response to the selection of the desired work, i.e. desired content, the user terminal device A transmits information indicative of the thus-selected content to the search server apparatus B, at step U5. In turn, the search server apparatus B collects predetermined statistical data of the artist who performed or created the selected content and updates the artist database C3 on the basis of the newly-collected statistical data, at step P3. At the same time, the billing information database C5 may also be updated. Then, information pertaining to the selected content is read out from the content database C4 and transmitted to the user terminal device A, at step P4. Thus, the user terminal device A receives or acquires the selected content and stores or reproduces the received content, at step U6.

When the user of the user terminal device A is to be charged or billed for the acquisition of the content, i.e. when the billing information database C5 is to be updated, the billing may be either on a content-by-content basis (i.e., per-amount-used basis) or on a fixed charge (flat rate) basis. In the case where the billing is on the fixed charge basis and when the user has attempted to acquire content beyond a predetermined limitation (e.g., three music pieces), there may be displayed a message to the effect that no more content can be supplied, or an extra charge may be made to the user.

Here, a detailed description is given about the recommendation search process carried out by the search server apparatus B (see step P2 of FIG. 3). FIG. 4 is a flow chart showing an example of the recommendation search process carried out by the search server apparatus B in the information delivery system of FIG. 1. The search server apparatus B starts up the recommendation search process upon receipt of a recommendation display instruction from the user terminal device A connected thereto via the communication network X, and terminates the recommendation search process after presenting one or more recommendable artists to the user terminal device A. The following paragraphs describe example details of the recommendation search process with reference to the flow chart of FIG. 4 in relation to a case where a music piece is supplied as user-desired content.

First, at step S1, the search server apparatus B determines whether the user in question (hereinafter “particular user”) has ever made a music piece selection through the search server apparatus B before; this determination is made on the basis of music-piece-selection history information stored in the user information database C1. If it is determined that the particular user has made a music piece selection before through the search server apparatus B (YES determination at step S1), the search server apparatus B obtains information about the artist of the music piece last selected by the particular user, at step S2. If, on the other hand, it is determined that the particular user has never made a music piece selection before through the search server apparatus B (NO determination at step S1), the search server apparatus B obtains information about one or more favorite artists registered by the particular user, at step S3. Namely, the search server apparatus B reads out the information about the particular user's favorite artists from the user information database C1. Then, at step S4, a search is made, on the basis of user characteristics stored in the recommendation index database C3, for any other users having registered the same favorite artists as registered by the particular user. At step S5, a determination is made, on the basis of a result of the search, as to whether there is any other user having registered the same favorite artists as the particular user. If it is determined that there is no other user having registered the same favorite artists, i.e. if no other user's ID is stored as the user characteristics in the recommendation index database C3, (NO determination at step S5), a search is made for any other users in accordance with another search condition or criterion at step S6. For example, the other search criterion may be one for testing the same age, sex, or the like as the particular (i.e., current) user having given the recommendation display instruction, or the area where the particular user lives, time period when the particular user accessed the search server apparatus B, present time of the year, or the like. On the basis of such an other search criterion, a search is made for any other users who have characteristics close to or similar to those of the particular user. If it is determined that even the use of the other search criterion can not find any other user having characteristics close to or similar to those of the current user (NO determination at step S7), preset artists are set as “recommendable artists” at step S8. Namely, newly-registered artists or the like set or updated by an information provider, such as a content provider, are set as recommendable artists.

If it is determined at step S5 that there are one or more other users having registered the same favorite artists as the particular (current) user (YES determination at step S5), or If it is determined at step S7 that there are one or more other users matching the other search criterion (YES determination at step S7), the search server apparatus B reads out the favorite artists, registered by the other users, from the user information database C1, at step S9. Then, at step S10, a most-frequently-designated (most-frequently-selected) artist among the read-out favorite artists, i.e., an artist having been so far designated by a greatest number of the users, is set as a recommendable artist. At step S11, the thus-set recommendable artist is presented to the user in accordance with the setting made at step S10 or S8. In presenting the recommendable artist, there may be displayed, along with the name of the recommendable artist, a listing of all music pieces performed or created by the recommendable artist, or a specific music piece most frequently selected by the other users, searched out under the other criterion, from among music pieces of the recommendable artists.

Namely, in the illustrated example, the most-frequently-designated or selected artist located from among the artists, currently registered as “favorite artists” by the other users who have characteristics close to those of the particular (current) user (i.e., other users who are supposed to share similar preference with the particular user because the other users have registered the same “favorite artists” as the particular or have characteristics, such as the age and sex, similar to those of the particular user), is presented to the particular as a “recommendable artist”. In case no other user similar to the current user could be searched out, one or more artists previously set by the information provider are presented to the current user as “recommendable artists”.

Note that the operation of step S1 in the above-described recommendation search process may be omitted as necessary. Namely, in a case where the record shows that the particular (current) user has never made a music piece selection through the search server apparatus B, “none” may be set as a previously-selected music piece of the particular user. In such a case, the search server apparatus B may jump to step S8 so that preset artists are set as “recommendable artists”.

If only one most-frequently-designated (selected) artist can not be identified from among the read-out favorite artists at step S10 of the recommendation search process, e.g. if two or more artists share the same highest frequency of designation or selection, then all of the two or more artists may be presented to the current user as “recommendable artists” or one or more artists preset by the information provider may be presented to the current user as “recommendable artists”.

Whereas the above-described recommendation search process is designed in such a manner that, each time a user accesses the search server apparatus B, the search server apparatus B statistically derive recommendable artists from the user information database, However, the present invention is not so limited. For example, there may be provided in advance a recommendation database. Among artists (e.g., top 100 frequently-designated artists) pertaining to frequently-downloaded content, one or more top-ranked artists of those having ever been selected by the same user or having been registered as favorites by the same user may be registered in the recommendation database as other candidate recommendable artists. In this case, for artists not registered in the recommendation database, the recommendation search process, shown in FIG. 4 as an exceptional process, may be carried out. In such a case, updating the recommendation database on a periodical basis (e.g., once per day) will be advantageous in that it can significantly lower processing loads on the search server apparatus B and reduce the time required until “recommendable artists” are presented to the requesting user after the initial access by the user.

In summary, the present invention is characterized by automatically setting recommendable artists and content performed or created by the recommendable artists by use of a statistical scheme and presenting the thus-set recommendable artists to a requesting user. With this arrangement, the present invention can present, to the requesting user, content that is considerably unexpected (beyond prior expectation of the user) and interesting to the user.

The present invention relates to the subject matter of Japanese Patent Application No. 2002-076673, filed on Mar. 19, 2002, the disclosure of which is expressly incorporated herein by reference in its entirety.

What is claimed is:

1. An information search method for use in a system including a database storing pieces of information about a plurality of users and artists and/or works registered in association with the plurality of users, said information search method comprising:
a first search step of, on the basis of information about a particular user, searching said database for one or more other users;
a second search step of searching said database for one or more artists or works, using, as augments, the one or more other users searched out from said database by said first search step; and
a step of presenting, to the particular user, a search result based on the one or more artists or works searched out from said database by said second search step.

2. An information search method as claimed in claim 1 wherein said first search step includes a step of specifying at least one artist or work in relation to the particular user, and a step of searching said database for the one or more other users using the specified at least one artist or work as an augment.

3. An information search method as claimed in claim 1 wherein said step of presenting includes a step of extracting, in accordance with a predetermined extraction criterion, at least one recommendable artist or recommendable work from among the one or more artists or works searched out from said database by said second search step, and said step of presenting presents the extracted recommendable artist or recommendable work to the particular user.

4. An information search method as claimed in claim 3 wherein the predetermined extraction criterion is based on a predetermined statistical algorithm.

5. An information search method as claimed in claim 4 wherein the predetermined statistical algorithm is designed to select, as the at least one recommendable artist or recommendable work, an artist or work having been designated most frequently by the one or more other users.

6. An information search method as claimed in claim 3 wherein, when said step of extracting could not extract any recommendable artist or recommendable work from among the one or more artists or works searched out from said database, said step of presenting a predetermined recommendable artist or recommendable work to the particular user.

7. An information search method as claimed in claim 2 wherein said step of specifying selects and specifies the at least one artist or work from among artists or works registered in said database in relation to the particular user.

8. An information search method as claimed in claim 2 wherein said step of specifying specifies the at least one artist or work in response to selection operation by the particular user.

9. An information search method as claimed in claim 1 wherein said second search step not only searches said database for one or more artists using, as augments, the one or more other users searched out from said database by said first step, and but also searches said database for works in which the one or more artists searched out from said database took part, and
wherein said step of presenting presents, to the particular user, both the one or more artists searched out from said database and the works in which the searched-out artists took part, as the search result.

10. An information search method as claimed in claim 1 wherein said first search step searches said database for one or more other users having a commonality in personal characteristic with the particular user.

11. An information search method as claimed in claim 2 wherein said first search step further includes a step of, when said first search step could not search out the one or more other users from said database using, as augments, the specified artist or work, searching said database for one or more other users having a commonality in personal characteristic with the particular user.

12. An information search method as claimed in claim 1 wherein said system is a system that sells or lends content of the works to the users or allows the users to use the content of the works.

13. An information search method as claimed in claim 12 wherein the works are music pieces, karaoke music pieces, movies, novels, comics, or cartoon films.

14. An information search method as claimed in claim 1 which is performed by a computer of a server connected to terminal devices of the plurality of users via a communication network.

15. An information search method as claimed in claim 14 wherein said step of presenting includes a step of transmitting the search result to the terminal device of the particular user via the communication network.

16. A program containing a group of instructions to cause a computer to perform the information search method of claim 1.

17. A machine-readable storage medium containing the program of claim 16.

18. An information search apparatus for use in a system including a database storing pieces of information about a plurality of users and artists and/or works registered in association with the plurality of users, said information search apparatus comprising a processor coupled with said database, said processor being adapted to:
search said database for one or more other users on the basis of information about a particular user;
search said database for one or more artists or works, using, as augments, the one or more other users searched out from said database; and
present, to the particular user, a search result based on the one or more artists or works searched out from said database.

19. An information search apparatus as claimed in claim 18 which is provided in a server connected to terminal devices of the plurality of users via a communication network.

20. An information search apparatus as claimed in claim 19 wherein the search result is presented to the particular user by said processor transmitting the search result to the terminal device of the particular user via the communication network in response to a request from the particular user.
